(19) United States
(12) Patent Application Publication
(10) Pub. No.: US 2017/0358948 A1
(43) Pub. Date: Dec. 14, 2017

(54) SYSTEMS AND METHODS FOR EXPEDITING REPAIRS OF UTILITY EQUIPMENT USING ELECTRONIC DIALOGS WITH PEOPLE

(71) Applicant: Intergraph Corporation, Madison, AL (US)

(72) Inventors: Daniel Maxson, Hartselle, AL (US); Phillip Barrett, Owens Cross Roads, AL (US); Timothy Ezell, Meridianville, AL (US); Adam Epling, Madison, AL (US); Eric Marlow Cooper, Huntsville, AL (US)

(21) Appl. No.: 15/621,087

(22) Filed: Jun. 13, 2017

Related U.S. Application Data
(60) Provisional application No. 62/453,592, filed on Feb. 2, 2017.
(60) Provisional application No. 62/349,460, filed on Jun. 13, 2016.

(51) Int. Cl. H02J 13/00; G06Q 50/06; G06Q 50/00; G06Q 10/06

(52) U.S. Cl. CPC H02J 13/0006; G06Q 10/0631; G06Q 50/06; G06Q 50/01

(57) ABSTRACT

In accordance with one embodiment of the invention, a utility management system locates and addresses potentially damaged utility equipment. A region manager determines a geographic region potentially affected by an environmental event and identifies a person in the geographic area. A utility communication device engages in an electronic dialog with the person, which include a location of a communication device used by the person. The message parser also parses the electronic dialog to determine equipment information, including type and condition, about utility equipment within a vicinity of the geolocation of the person. An inventory database provides the identity of potentially damaged utility equipment, including information relating to geolocation. The equipment manager generates a repair list that includes at least some of the identified potentially damaged utility equipment and determines repair equipment to repair the potentially damaged utility equipment on the repair list.

### RELATED APPLICATION

This application claims priority to U.S. Application No. 62/453,592, entitled “Systems and Methods for Expediting Repairs of Utility Equipment Using Electronic Dialogs with People” and filed Feb. 2, 2017, and U.S. Application No. 62/349,460, entitled “Civic Recon—Utilities damage assessment using customer input and social media connectors” and filed Jun. 13, 2016, the contents of which are hereby incorporated by reference in their entireties.

### FIELD OF THE INVENTION

The invention generally relates to expediting repairs of utility equipment damaged due to environmental events and, more particularly, the invention relates to determining equipment for making the repairs based on electronic dialogs conducted with persons within the vicinities of the damaged utility equipment.

### BACKGROUND OF THE INVENTION

Catastrophes caused by natural disasters such as earthquakes, floods, tsunamis, snowstorms, and hurricanes can disrupt services provided by utility companies by damaging equipment in their infrastructures. In some circumstances, a company may routinely monitor its infrastructure in a manner that allows the company to estimate, remotely, where damage has occurred. However, this monitoring is limited to rough estimates of the location of potential damage. The monitoring cannot inform the company of the precise location of damage, the nature of the damage, or the measures required to repair the damage. Because the company's existing technology is inadequate to obtain the information needed to repair damage to infrastructure, the company needs personnel to conduct onsite visits to obtain the information necessary to repair the damage. For example, personnel may sweep a geographic region to identify the location of damaged utility equipment and recommend equipment needed to make repairs.

After personnel collect this information on behalf of the utility company, the utility company may send out a crew with the recommended equipment. However, because the personnel may lack the technical expertise required to assess damage fully, the crew may discover that it has received incomplete information. Thus, the crew may arrive at a site still inadequately equipped to repair damage. For example, even if a crew has been notified that it needs to remove felled tree limbs to access a broken transformer, the crew may learn onsite that its chainsaws are insufficiently powerful to cut the limbs into manageable portions for hauling away, or that it needs a truck with larger capacity to hold the limbs. In another example, personnel may have made errors during its initial surveillance, and the crew may learn onsite that it has brought the incorrect type of transformer. The crew then typically leaves the site to obtain the proper equipment. Undesirably, each trip wastes time and delays the restoration of the utility company's service.

### SUMMARY OF VARIOUS EMBODIMENTS

In accordance with one embodiment of the invention, a utility management system locates and addresses potentially damaged utility equipment. A region manager determines a geographic region potentially affected by an environmental event and identifies a person in the geographic area. A utility communication device engages in an electronic dialog with the person. The electronic dialog includes at least one electronic message.

A message parser is operatively coupled with the utility communication device. The message parser parses the at least one electronic message to determine the geolocation of the communication device used by the person in the electronic dialog. The message parser also parses the electronic dialog to determine equipment information about utility equipment within a vicinity of the geolocation of the person. The equipment information includes the type of utility equipment and a condition of the utility equipment.

An inventory database provides, based on the geolocation of the communication device and the equipment information, the identity of potentially damaged utility equipment. The utility equipment in the inventory database has associated information relating to geolocation. Further, an equipment manager is operatively coupled with the inventory database. The equipment manager generates a repair list that includes at least some of the identified potentially damaged utility equipment. The equipment manager determines repair equipment to repair the potentially damaged utility equipment on the repair list.

The region manager may receive at least one electronic message regarding the environmental event from an environmental events notification system, and may determine the geographic region based on the at least one electronic message. The region manager may communicate with a database of people to select a customer of the utility service residing in the geographic area.

The utility communication device may engage in the electronic dialog by sending an electronic message to a communication device of the person. The electronic message may be a text message that requests an observation from the person. The electronic message may be configured to activate, on the communication device, an application for managing the electronic dialog. Further, the utility communication device may receive, from the communication device, at least one electronic message including observations by the person regarding the vicinity of the geolocation, the observations including image data, text, or both.

The message parser may apply image analysis, text analysis, or both to the observations received from the communication device of the person to determine the type of utility equipment, the condition of the utility equipment, or both. The message parser may parse the electronic dialog to determine impediments, in the vicinity of the geolocation of the person, to repairing the utility equipment. The message parser may parse the electronic dialog by applying image analysis, text analysis, or both to the observations received from the communication device of the person. The message parser may determine global positioning coordinates from the geolocation metadata of the at least one electronic message.

The equipment manager may retrieve, from the inventory database, utility equipment with a geolocation within a predetermined distance of the geolocation of the communication device. The equipment manager may identify, from the retrieved utility equipment, potentially damaged utility equipment based on the type of utility equipment determined from parsing the electronic dialog. For each identified potentially damaged utility equipment on the repair list, the equipment manager may determine repair equipment for extracting the potentially damaged utility equipment and the repair equipment for installing new utility equipment.

For each impediment to repairing the utility equipment determined by parsing the electronic dialog, the equipment manager may determine the repair equipment for removing the impediment. The equipment manager may store the condition of the utility equipment with the retrieved identity of the utility equipment in the inventory database.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a utility management system for locating and addressing potentially damaged utility equipment, in accordance with embodiments of the invention;

FIG. 2 schematically shows a utility management server system used in the system of FIG. 1, implemented in accordance with one embodiment of the invention;

FIG. 3 depicts an exemplary flow diagram for locating and addressing potentially damaged utility equipment;

FIG. 4 is an exemplary user interface displayed by the utility management system, used to identify a geographic region of interest;

FIGS. 5 and 6 are exemplary user interfaces displayed by applications executing on communicating devices of people;

FIG. 7 depicts an exemplary use of a camera on a person's computing device to obtain information about a location in the geographic region of interest, to be sent to the utility management system; and

FIG. 8 is an exemplary user interface, displayed by the utility management system, for managing received information about potential damage in the geographic region of interest.

### DESCRIPTION OF ILLUSTRATIVE EMBODIMENTS

Illustrative embodiments of the invention enable utility companies to obtain more useful information relevant to damaged infrastructure prior to sending crews to sites to make repairs. To that end, a utility management system engages in an electronic dialog with a person in an affected geographic area. Using the responses of the person and geolocation information, the utility management system can determine appropriate repair equipment to bring to the site.

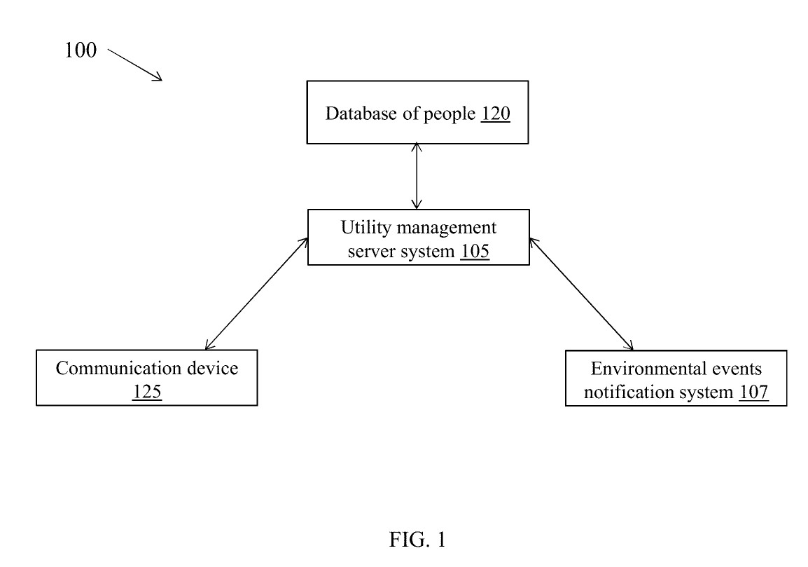

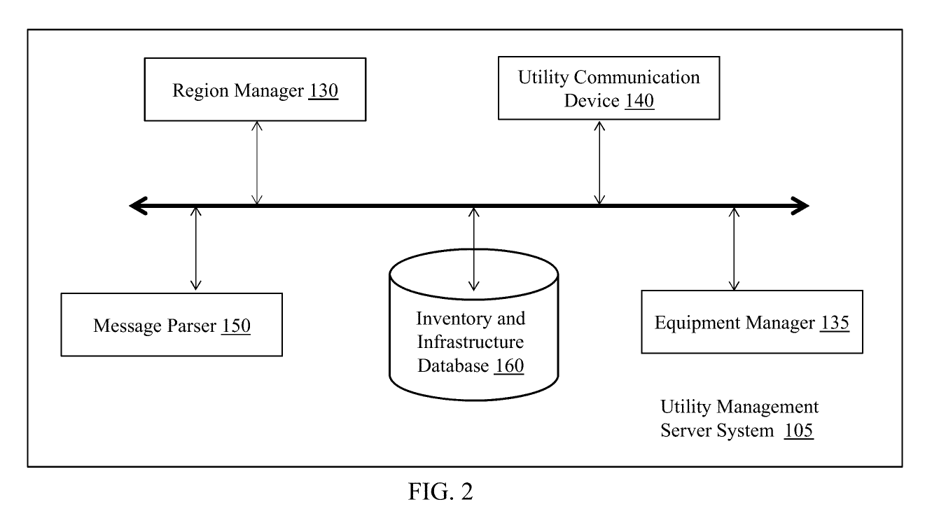

Specifically, FIG. 1 depicts the above noted platform 100 by which companies can use electronic dialogs to solicit observations from people located near sites of interest. The platform 100 includes a utility management server system 105 (depicted in more detail in FIG. 2) that receives notifications of environment events from an environmental events notification system 107. The utility management server system 105 determines the status of infrastructure via the inventory and infrastructure databases 160 (part of the utility management server system 105 and shown in FIG. 2, which is discussed immediately below). The utility management server system 105 uses information from these two systems 107, 160 to identify a geographic area of interest, and uses a database of people 120 to identify people located within this geographic area.

FIG. 2 shows more details of the utility management server system 105. As shown, the system 105 includes a utility communication device 140, which may access a person through his or her communication device 125 (e.g., mobile computing device) and request observations about the person's immediate environment. The person may provide responses via text descriptions of his or her surroundings or by capturing images using a camera on the communication device 125, by way of example.

Through an iterative process, the utility communication device 140 may engage the person in an electronic dialog, guiding the person through targeted inquiries until the system 105 obtains complete information for addressing the damaged utility equipment at a location of interest within the person's vicinity. Some of the inquiries may be crafted based on already known information about the infrastructure at the location of interest (e.g., stored in the inventory and infrastructure database 160). Other inquiries may be crafted based on observations that the person previously provided in the dialog. In this manner, the utility communication device 140 sends inquiries based on the information that it has stored about the utility company's infrastructure, and further adapts its inquiries based on the information that the person provides. This approach enables the utility management server system 105 to gather information robustly and to determine the full complement of repair equipment needed to address damaged infrastructure at a particular location of interest.

Each of these components within the utility management server system 105 is operatively connected by any conventional interconnect mechanism. FIG. 2 simply shows a bus to achieve communication between the components. Those skilled in the art should understand that this generalized representation can be modified to include other conventional direct or indirect connections. Accordingly, discussion of a bus is not intended to limit various embodiments.

Indeed, it should be noted that FIG. 2 only schematically shows each of these components. Those skilled in the art should understand that each of these components can be implemented in a variety of conventional manners, such as by using hardware, software, or a combination of hardware and software, across one or more other functional components. For example, the utility communication device 140 may be implemented using a plurality of microprocessors executing firmware. As another example, the utility communication device 140 may be implemented using one or more application specific integrated circuits (i.e., “ASICs”) and related software, or a combination of ASICs, discrete electronic components (e.g., transistors), and microprocessors. Accordingly, the representation of the utility communication device 140 and other components in FIG. 2 is for simplicity purposes only. In fact, in some embodiments, the utility communication device 140 of FIG. 2 may be distributed across a plurality of different machines—not necessarily within the same housing or chassis.

It should be reiterated that the representations of FIGS. 1 and 2 are significantly simplified representations of actual platforms and respective components. Those skilled in the art should understand that such platforms and respective components may have many other physical and functional components, such as other processing modules and short-term memory.

Accordingly, this discussion is in no way intended to suggest that FIGS. 1 and 2 represent all of the elements of the platform 100 in general or the utility management server system 105 in particular.

### Identifying the Potentially Affected Geographic Region and Persons to Engage in Electronic Dialog

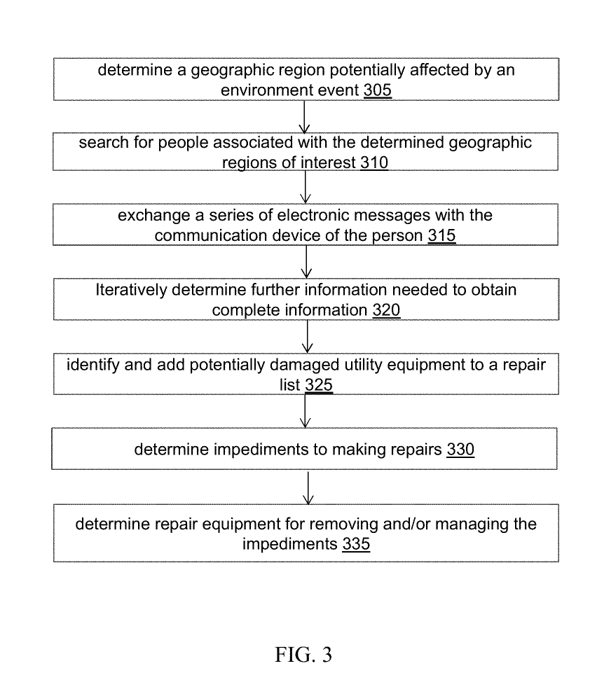

FIG. 3 shows a process of locating and addressing potentially damaged utility equipment. It should be noted that the following embodiments are merely illustrative, and additional solutions for determining the geographic region may be substituted for any of the approaches described herein.

The process begins at step 305, in which the region manager 130 determines a geographic region potentially affected by an environment event. In one embodiment, the region manager 130 determines the geographic region based on a notification from an environment events notification system 107. Although FIG. 1 depicts a single notification system 107, the utility management server system 105 may communicate with different systems 107 associated with organizations that provide information about environmental events. For example, government emergency response agencies (e.g., the Federal Emergency Management Agency), government forecasting agencies (e.g., National Weather Service), weather-related news agencies (e.g., AccuWeather, The Weather Channel), and general news agencies may offer services through their respective notification systems 107 to notify the public about noteworthy environmental events. A notification system 107 may send the region manager 130 information regarding events such as, but not limited to, tornadoes, hurricanes, floodings, and wildfires. The information may include geographic indicators such as city, county, neighborhood, region or landmark names. The region manager 130 may determine a geographic region of interest based on the information in the notification.

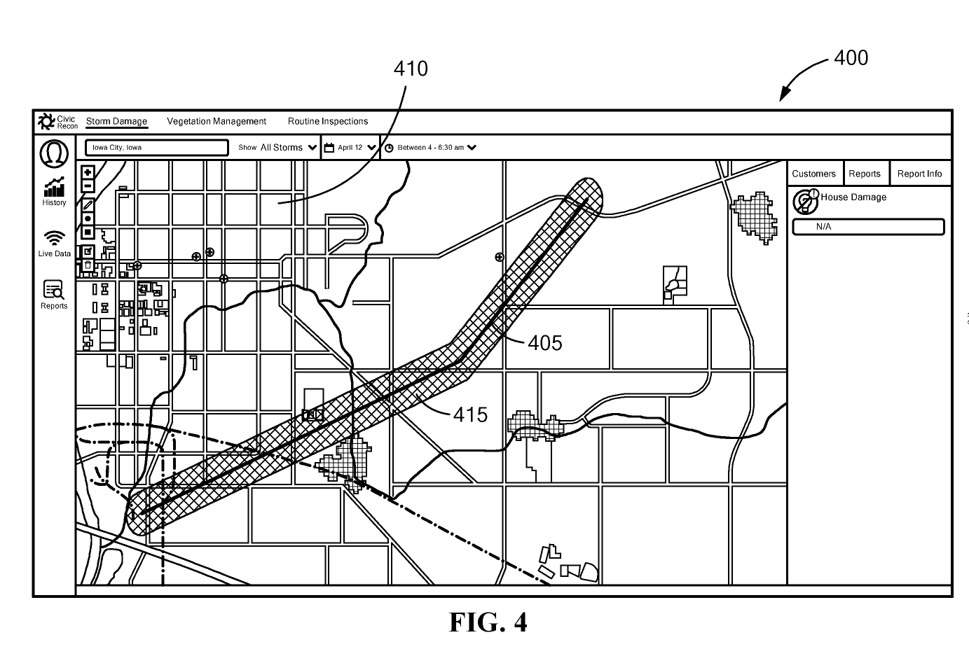

In one example, the National Weather Service may send, via its notification system 107, information about the projected track of a snowstorm. As depicted in the user interface 400 of FIG. 4, the region manager 130 may display the projected track 405 on a map 410. A user of the utility management server system 105 may define a geographic region of interest based on the projected track. In this embodiment, the region 415 has been defined as the locations within a predetermined distance from the projected track of the snowstorm.

In another embodiment, an equipment manager 135 monitors the status of utility equipment within its infrastructure and communicates with the region manager 130 so that the region manager 130 may determine the geographic region of interest, based on the locations of utility equipment that appear to be non-functional. For example, each item of utility equipment may be configured to monitor its own activity and communicate its status to an equipment manager 135. Alternatively, each item may be equipped with a separate device, such as a sensor, to perform this function. When an environmental event damages an item of utility equipment, the equipment manager 135 fails to receive a status update corresponding to the item at the expected time. The equipment manager 135 may retrieve the location of the non-responsive utility equipment from an inventory and infrastructure database 160, and the region manager 130 may derive the geographic region(s) of interest accordingly. For example, for each location of non-responsive utility equipment identified by the equipment manager 135 and inventory and infrastructure database 160, the region manager 130 may designate an area within a predetermined distance of the location as a geographic region of interest.

In some embodiments, a region manager 130 waits until the environmental event, in theory, completes its damage before acting upon information from the equipment manager 135. Then, the region manager 130 aggregates locations to determine the geographic region(s) of interest. For example, the region manager 130 may wait until it receives a notification from the notification system 107 that the environmental event has lapsed (e.g., a hurricane has moved out to sea, a tornado has dissipated). Alternatively, the region manager 130 may wait until a predetermined period of time has elapsed since receiving the first location of non-responsive utility equipment. In another example, the region manager 130 may wait until a predetermined period of time has elapsed since receiving the most recent location of non-responsive utility equipment.

Then, the region manager 130 may apply sets of rules to the locations to determine geographic region(s) of interest. For example, if the location of one item of non-responsive utility equipment is not within a threshold distance of another location, then a geographic region of interest may be the area within a predetermined radius of the location. In another example, the region manager 130, in conjunction with the equipment manager 135, may identify clusters of non-responsive utility equipment. For example, the region manager 130 may group locations as a cluster if each location falls within a threshold distance of another location in the group. The geographic region of interest may be the area within a predetermined radius of the average of the locations (the length of the predetermined radius may depend on the number of members in the group). Other sets of rules may be applied, as would be appreciated by one of ordinary skill in the art.

In further embodiments, the region manager 130 may determine the geographic region(s) of interest based on locations in the infrastructure that are not receiving the utility service. For example, the utility company may have installed sensors at various locations throughout the infrastructure to monitor its performance. The sensors may verify whether the utility service is being properly provided at their respective locations and communicate this information to the equipment manager 135. Thus, when an environmental event damages utility equipment, sensors proximate to the affected area (s) may detect that the utility is no longer being provided and transmit the lack of service to the equipment manager 135. Using the locations of the sensors reporting lack of service and information about the utility equipment that would normally service those locations, the region manager 130 may determine the geographic regions that should be investigated to obtain information for making repairs.

In some embodiments, the region manager 130 retrieves the locations and identities of all utility equipment falling within the geographic regions of interest from an inventory and infrastructure database 160. The region manager 130 may compile a list of utility equipment for which observations are desired.

The region manager 130 may include or communicate with a database 120 to search for people associated with the determined geographic regions of interest (step 310). Because these people may be proximate to areas where utility equipment has been affected, they may be able to provide the region manager 130 with information necessary for making repairs. In some embodiments, the database 120 may store information such as the address(es) where a person receives the service (e.g., residential addresses, commercial addresses) and contact information for the person (e.g., a telephone number associated with a mobile computing device). Alternatively, a person in the database 120 need not be a customer of the utility company. Instead, the person may be affiliated with a location and have previously expressed willingness to provide information to the utility company about his or her vicinity, should be occasion arise. For example, a person may be a government official who can expected to be present at a particular location during business hours, or a business owner who is likely to be onsite at his or her business during predetermined hours. In any case, the region manager 130 may search the database 120 based on addresses or geographic regions to retrieve contact information for persons who may become valuable sources of information about utility infrastructure.

### The Electronic Dialog

To engage a person, the utility communication device 140 exchanges a series of electronic messages with the communication device 125 of the person (step 315). For example, the utility communication device 140 may send text messages requesting observations about the person's immediate surroundings, and the person may respond with text messages from his or her communications device 125. In some embodiments, the person may embed images captured with a camera on the communication device 125 into any of the text messages. In another example, the communication device 125 executes an application, which may be activated by an electronic message from the utility communication device 140. For example, the application may activate in response to a text message sent from a contact number associated with the utility communication device 140 or an e-mail message from the utility communication device 140 sent to the e-mail address that the person provided when the person registered to obtain the application on his or her communication device 125. The utility communication device 140 may send requests for observations through the application, and the customer may respond via the same forum.

As described above, through an iterative process, the utility communication device 140 and a message parser 150 may guide the person through a series of inquiries. For example, the utility communication device 140 may use a predetermined algorithm to create the initial inquiries for engaging a person in dialog. Alternatively, the inquiries may be created using a machine learning algorithm or artificial intelligence. In another embodiment, the inquiries may be generated by personnel of the utility communication device 140, who evaluate the electronic messages from the person to determine the information that still needs to be obtained.

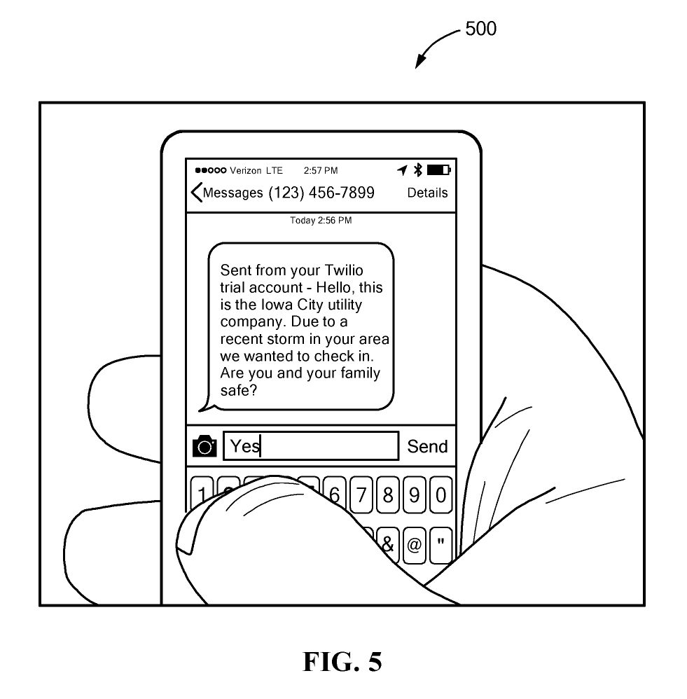

In one example, after identifying a person whose stored address falls within a geographic region of interest, the utility communication device 140 may send an inquiry regarding the person's safety to his or her communication device 125. The utility communication device 140 may send a short message service (SMS) to a telephone number of the person, as depicted in the user interface 500 of FIG. 5. If the person is physically safe, the person may reply with an affirmative SMS message, and the utility management server system 105 continues the electronic dialog.

In another example, after identifying a person whose stored address falls within a geographic region of interest, the utility communication device 140 may send an inquiry regarding the person's current location. The person may respond with his or her location (e.g., address, landmark, identity of commercial center). Although the message parser 150 may use the person's response, the message parser 150 may also parse geolocation metadata for the electronic message to identify the person's location, and use those coordinates instead of the person's response.

In some situations, the response may indicate that even though the stored address associated with the person falls within the geographic region of interest, the person is not currently within the region. For example, the person may be out of town on vacation or a business trip, or in a different part of town running errands. If the person may be able to provide meaningful information within a desirable period of time, e.g., upon returning home from errands, the utility communication device 140 may temporarily suspend the electronic dialog. The dialog may resume after a predetermined period of time. For example, after the period of time elapses, the utility communication device 140 may attempt to resume the electronic dialog by requesting an update about the person's current availability to provide observations (e.g., “Are you home now?”). Alternatively, the electronic dialog may remain suspended until the person sends an electronic message indicating his or her availability to provide observations (e.g., “I am home now.”). However, if the person will be unable to provide meaning information (e.g., “I am out of town for the next week”), the management system 105 may terminate the electronic dialog and find another person to engage.

After the person confirms that he or she is available to provide observations within the geographic region of interest, the utility communication device 140 may send inquiries regarding the person's vicinity. In some embodiments, the utility communication device 140 assumes that all of the user's observations concern the geographic region of interest. In other embodiments, each time the person provides an observation, the corresponding electronic message may include geolocation metadata that identifies a location of the person's communication device 125. The message parser 150 may parse the metadata to determine the communication device's 125 geolocation, and associate the geolocation with the observation provided by the person.

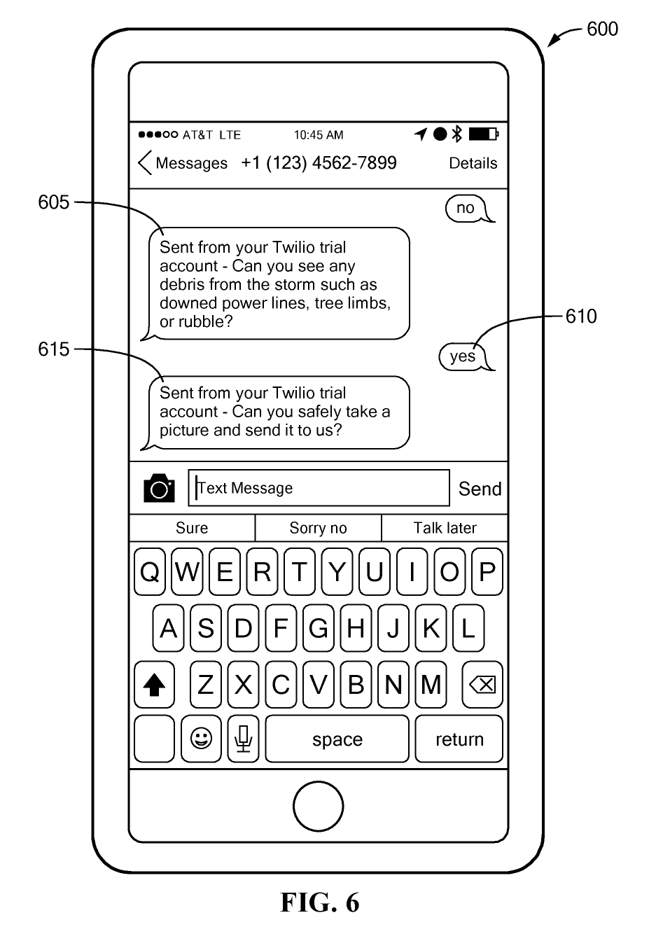

For example, as depicted in the user interface 600 of FIG. 6, the utility communication device 140 may send an inquiry 605 regarding visible damage in the person's location. The inquiry may be a general inquiry (e.g., “Do you see damage?”), although inquiries of any specificity may be used (e.g., “Are any power lines downed?”, “Are any tree limbs broken?”, “Is there any flooding in your neighborhood?”). If the person confirms 610 that his or her location has visible damage, the utility communication device 140 may request 615 that the person capture and send images of the damage, if possible.

In another example, the person may report on visible damage without specific prompting for that particular type of damage from the utility communication device 140. For example, the utility communication device 140 may send a general inquiry for information about visible damage. The user may observe broken tree limbs in the middle of the road that were felled by a recent snowstorm. The person may send an electronic message stating “fallen tree limbs”. Because the tree limbs lie within the geographic region of interest and may block the utility company's ability to travel to and/or subsequently access damaged utility equipment, the utility communication device 140 may request information relevant for removing the tree limbs. An inquiry may request an estimate of the number of broken tree limbs and estimated sizes for each one. Another inquiry may request that the person capture images of the damage.

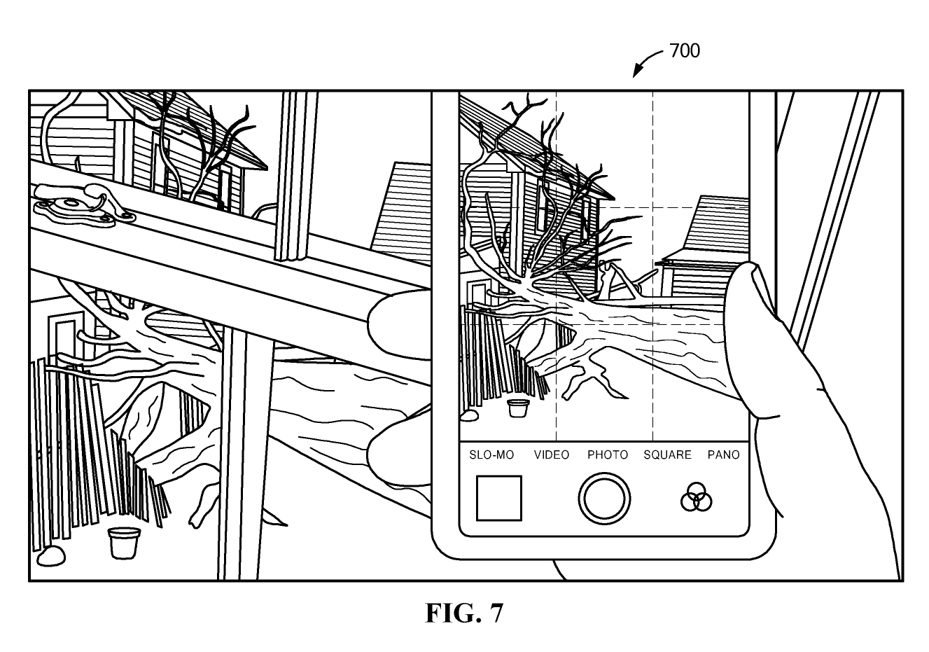

The user may use a camera on his or her communication device 125 to capture images of visible damage. FIG. 7 depicts a user photographing a toppled tree in the backyard, and the user may attach this image to a text message to send to the utility management server system 105.

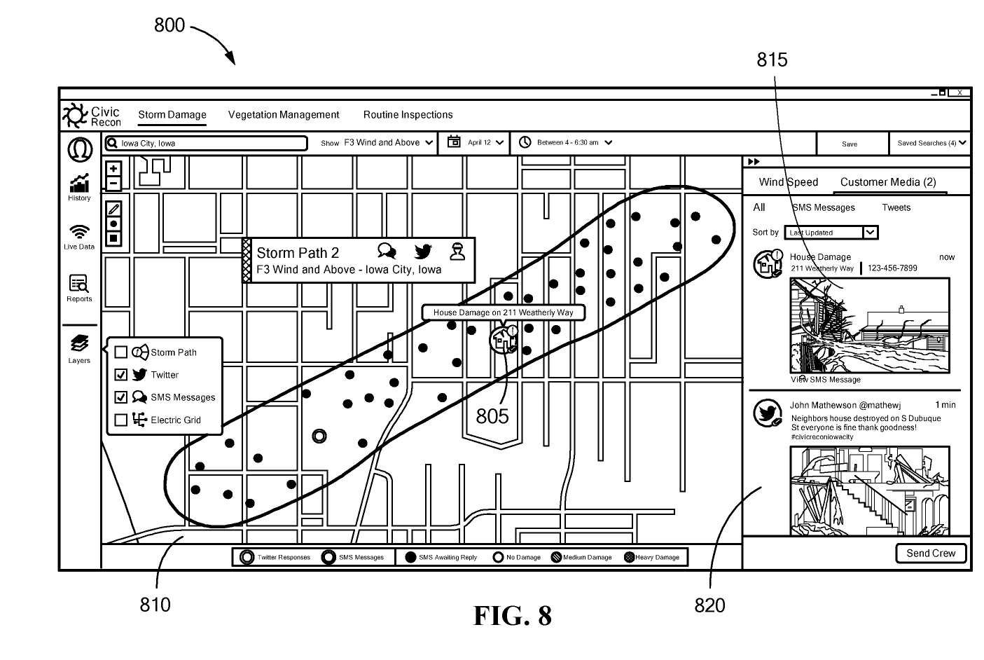

In some embodiments, the utility management server system 105 marks a location on a map corresponding to the person's geolocation to indicate that it has received information about that position. The message parser 150 parses the person's message to obtain the geolocation and the utility management server system 105 displays an icon 805 at the corresponding position on the map 810, as depicted in the user interface 800 of FIG. 8. When a user selects the icon 805, the utility management server system 105 may display the image(s) obtained at that position. In the embodiment of FIG. 8, the utility management server system 105 displays the image 815 in a vertical panel 820 of the interface 800.

The message parser 150 may evaluate the contents of each image, via image analysis or human observation, to determine what further information is needed (step 320). Suppose an image focuses upon a particular broken limb lying in the road, but another limb lies on the periphery of the image. The utility communication device 140 may request information regarding the peripheral limb. Other inquiries may request images from different perspectives, e.g., a wide-angle image that captures the totality of the damage, as well as images focusing on different parts of the damage. Additionally, inquiries may request images of trees along the road; even if some limbs have not broken off trees yet, they may be precarious and nevertheless fall between the time the person captures their images and the time a crew arrives at the site. In some embodiments, after the utility communication device 140 obtains the relevant information for the site, the information is compiled into a summary and sent to the person for confirmation, which the person may affirm.

In another example, the person may observe a utility pole whose utility lines may either be severed or strained. The person may send a text message stating “utility pole damaged” to the utility communication device 140. The message parser 150 may parse this communication to determine that the type of utility equipment that has been affected is a utility pole. In some embodiments, given a utility company's experience in fixing damaged utility poles, the utility communication device 140 may initially send solely inquiries requesting textual responses. For example, the utility communication device 140 may send a series of inquiries requiring a “yes/no” response to gauge the scope of the damage. The first inquiry may ask “How many utility poles are affected?” The customer may reply “1”. The next inquiry may ask “Is the utility pole still standing?”, and if the reply is “yes”, the following inquiry may ask “Are any utility lines broken?” In this manner, the utility communication device 140 may obtain confirmation from the customer regarding a particular type of damage to the utility infrastructure at the customer's current location.

In some embodiments, inquiries may request images so that the utility company may gain a better understanding of the damage. For example, an inquiry may state “Please send a picture of the broken utility lines.” From the customer's response, the utility company may understand the position of the broken lines (e.g., dangling mid-air, lying on the sidewalk), the risk the exposed lines pose to the public (and consequently, the urgency of this particular repair), and the scope of safety precautions that its crew would need to take when making repairs.

In another example, after the person states that the utility pole itself has been damaged, the utility communication device 140 may inquire “Is the pole broken?” and “Has the pole toppled over?” Additional inquiries may request images of the utility pole. As a result, the utility company knows whether the pole needs to be repositioned and reinforced at its base, or removed and replaced altogether.

In some situations, the person may indicate that an area cannot be accessed. For example, the local government may have cordoned off one or more streets surrounding the location of interest to prevent vehicular or pedestrian traffic while debris is being removed, or while other incidents in that location are being investigated (e.g., a car accident, criminal activity). Alternatively, a street may have flooded, thereby impeding further travel by the person. The person may inform the utility communication device 140 of the barrier and its nature, and the utility communication device 140 may send further inquiries regarding the barrier. Thus, the utility company obtains information relevant to its ability to navigate within the geographic region of interest, and use this information to prioritize later the utility equipment that requires repair based on location and accessibility.

In some embodiments, when the person's geolocation falls within a predetermined distance of utility equipment for which the utility company desires observations, the utility communication device 140 may send inquiries specific to utility equipment of interest. The utility communication device 140 may direct the person to the location of the utility equipment. For example, the electronic message may include an address. Alternatively, the utility company may have captured and stored an image of the utility equipment when it was first installed at the site, and the utility communication device 140 may retrieve this image from an inventory and infrastructure database 160 to display to the customer. Thus, the customer is informed of the utility equipment in its environmental context and may survey the neighborhood to find the equipment. Alternatively, the utility communication device 140 uses the geolocation of the utility equipment to obtain an image of its environmental context from a web mapping service, such as Google Maps offered by Google, Inc. of Mountain View, Calif. In some embodiments, the utility communication device 140 may send an image of the utility equipment itself, such as an image from the equipment manufacturer's catalog, to aid the person in location the utility equipment.

After the person confirms that he or she has located the utility equipment of interest, the utility communication device 140 may send inquiries regarding its condition. For example, the inventory and infrastructure database 160 may store information for determining the functional state of the utility equipment. For example, a transformer may include a set of lights. When all of the lights are lit, the transformer may be operational. If the lights exhibit any other behavior, the particular behavior may indicate the problem with the transformer. For example, a transformer that is damaged beyond repair and requires replacement may have all of its lights unlit or blinking. However, if some lights are lit and others are blinking or unlit, the transformer may simply need some repairs, but not replacement. In some embodiments, each light corresponds to a subsection of the transformer, and in other embodiments, the pattern of lights corresponds to the problem with the transformer. The utility communication device 140 may send a numbered list of possible behaviors of the lights, and the customer may select the option that he or she observes on the transformer. Alternatively, the utility communication device 140 may iteratively present the possible behaviors to the customer in a series of electronic messages, and the person may respond “yes” or “no” to each behavior. Thus, the utility communication device 140 may determine the condition of the utility equipment.

Alternatively, the utility communication device 140 may request the person to describe the physical state of the utility equipment. Because the inquiry is open-ended, the response may be analyzed using natural language processing or other forms of artificial intelligence to determine the condition of the utility equipment. The person may capture and send images of the utility equipment, and the message parser 150 may process the images using image analysis to determine the condition of the utility equipment. In some embodiments, personnel for the utility company may determine the condition based on their judgment by analyzing the images. If the analysis concludes that the person has provided inadequate information, the utility communication device 140 prepares follow-up inquiries. Thus, the utility communication device 140 may iteratively question the person about what he or she can observe until the responses permit the utility communication device 140 to draw conclusions regarding the condition of the utility equipment.

In various embodiments, after the utility communication device 140 determines that the utility equipment is potentially damaged, the equipment manager 135 retrieves an entry from the inventory and infrastructure database 160 corresponding to the utility equipment. The equipment manager 135 may use the type of utility equipment and the geolocation of the person's communication device 125 to obtain the entry. For example, the inventory and infrastructure database 160 may first identity entries for utility equipment within a predetermined distance of the geolocation of the communication device 125. Since the geolocation of the communication device is likely offset from the geolocation of the utility equipment, the equipment manager 135 permits some deviation in searching for the relevant utility equipment. Then, the equipment manager 135 selects the entry corresponding to the type of utility equipment for which the person has provided observations. Further, the equipment manager 135 may store the condition of the utility equipment, thereby updating the entry.

Each time the equipment manager 135 updates an entry in the inventory and infrastructure database 160 in this manner, the equipment manager 135 may add the identified utility equipment to a repair list (step 325). Additionally, the utility equipment's entry in the inventory and infrastructure database 160 may store the repair equipment needed to repair the utility equipment, depending on the condition of the latter, and the equipment manager 135 may add this repair equipment to the repair list, or a separate list dedicated to repair equipment. Thus, the equipment manager 135 may identify equipment for repairing damaged utility equipment (e.g., tools and/or replacement parts), or equipment for extracting damaged utility equipment in its entirety and installing a replacement.

The message parser 150 and equipment manager 135 may determine impediments to repairing the utility equipment (step 330). In some embodiments, these impediments may have been detected from images that the person sent of the utility equipment when determining its condition. For example, an image of a damaged transformer may have also included a tree limb that has fallen on top of or blocks access to the transformer. An image of a utility pole may reveal the position of severed live wires, thereby indicating the precautions the crew will need to protect themselves and limiting the manner in which a crew may approach the pole to make repairs. The equipment manager 135 may determine repair equipment for removing and/or managing the impediment, and add this equipment to its list (step 335).

The utility communication device 140 may also send the person inquiries regarding impediments to repairing the utility equipment. In some embodiments, an inquiry may request a panoramic image, or a series of images, of the utility equipment's surroundings, which is then analyzed by the message parser 150 to identify possible impediments. For example, the image(s) may reveal that part of the street has been flooded. The utility management server system 105 may delay sending a crew to the site until the flooding subsides.

In another example, the image(s) may reveal that the street remains unplowed, despite heavy snowfall. The utility management server system 105 may delay sending a crew, but may alternatively add snowplows to its list of repair equipment to resolve access to damaged utility equipment, on its own. In another situation, the image(s) may reveal that although the street has been plowed, the snow has been piled in a location that impedes access to the damaged utility equipment. The equipment manager 135 may add snow removal equipment (e.g., shovels, snowplows, or backhoe, depending on the nature of the impediment) to its list of repair equipment.

Alternatively, the utility communication device 140 may request the person to identify and describe any impediments to the utility equipment. Because the inquiry is open-ended, the response may be analyzed using natural language processing or other forms of artificial intelligence to determine the presence of impediments. If the utility communication device 140 concludes that the person has provided inadequate information, the utility communication device 140 prepares follow-up inquiries and may iteratively question the person until he or she provides enough information to determine the nature of the impediment and repair equipment needed to address it.

It should be noted that this process is substantially simplified from a longer process that normally would be used to locate and address potentially damaged utility equipment. In addition, some of the steps may be performed in a different order than that shown, or at the same time. Those skilled in the art therefore can modify the process as appropriate. Moreover, as noted above and below, many of the components noted are but one of a wide variety of different components that may be used. Those skilled in the art can select the appropriate components depending upon the application and other constraints. Accordingly, discussion of components is not intended to limit all embodiments.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a tangible removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software. The embodiments of the invention described above are intended to be merely exemplary; numerous variations and modifications will be apparent to those skilled in the art. All such variations and modifications are intended to be within the scope of the present invention as defined in any appended claims.

Although the above discussion discloses various exemplary embodiments of the invention, it should be apparent that those skilled in the art can make various modifications that will achieve some of the advantages of the invention without departing from the true scope of the invention.

What is claimed is:

1. A utility management system for locating and addressing potentially damaged utility equipment, the system comprising:
a region manager configured to determine a geographic region potentially affected by an environmental event and identify a person in the geographic area;
a utility communication device configured to engage in an electronic dialog with the person, the electronic dialog including at least one electronic message;
a message parser operatively coupled with the utility communication device, the message parser configured to parse the at least one electronic message to determine the geolocation of the communication device used by the person in the electronic dialog, the message parser also being configured to parse the electronic dialog to determine equipment information about utility equipment within a vicinity of the geolocation of the person, the equipment information including the type of utility equipment and a condition of the utility equipment;
an inventory database for providing, based on the geolocation of the communication device and the equipment information, the identity of potentially damaged utility equipment, the utility equipment in the inventory database having associated information relating to geolocation; and
an equipment manager operatively coupled with the inventory database, the equipment manager being configured to generate a repair list including at least some of the identified potentially damaged utility equipment, the equipment manager also being configured to determine repair equipment to repair the potentially damaged utility equipment on the repair list.

2. The utility management system of claim 1, wherein the region manager is further configured to:
receive, from an environmental events notification system, at least one electronic message regarding the environmental event, and
determine the geographic region based on the at least one electronic message.

3. The utility management system of claim 1, wherein the region manager is further configured to:
communicate with a database of people to select a customer of the utility service residing in the geographic area.

4. The utility management system of claim 1, wherein the utility communication device is configured to engage in the electronic dialog by sending an electronic message to a communication device of the person.

5. The utility management system of claim 4, wherein the electronic message is a text message that requests an observation from the person.

6. The utility management system of claim 4, wherein the electronic message is configured to activate, on the communication device, an application for managing the electronic dialog.

7. The utility management system of claim 1, wherein the utility communication device is configured to receive, from the communication device, at least one electronic message including observations by the person regarding the vicinity of the geolocation, the observations including image data, text, or both.

8. The utility management system of claim 7, wherein the message parser is configured to apply image analysis, text analysis, or both to the observations received from the communication device of the person to determine the type of utility equipment, the condition of the utility equipment, or both.

9. The utility management system of claim 7, wherein the message parser is configured to parse the electronic dialog to determine impediments, in the vicinity of the geolocation of the person, to repairing the utility equipment.

10. The utility management system of claim 9, wherein the message parser is configured to parse the electronic dialog by applying image analysis, text analysis, or both to the observations received from the communication device of the person.

11. The utility management system of claim 1, wherein the message parser is configured to determine global positioning coordinates from geolocation metadata of the at least one electronic message.

12. The utility management system of claim 1, wherein the equipment manager is configured to:
retrieve, from the inventory database, utility equipment with a geolocation within a predetermined distance of the geolocation of the communication device; and
identify, from the retrieved utility equipment, potentially damaged utility equipment based on the type of utility equipment determined from parsing the electronic dialog.

13. The utility management system of claim 1, wherein the equipment manager is configured to determine the repair equipment by determining, for each identified potentially damaged utility equipment on the repair list, repair equipment for extracting the potentially damaged utility equipment and the repair equipment for installing new utility equipment.

14. The utility management system of claim 9, wherein the equipment manager is configured to determine the repair equipment by determining, for each impediment to repairing the utility equipment determined by parsing the electronic dialog, repair equipment for removing the impediment.

15. The utility management system of claim 1, wherein the equipment manager is configured to store, in the inventory database, the condition of the utility equipment with the retrieved identity of the utility equipment.

16. A method of controlling a utility management system to locate and address potentially damaged utility equipment, the method comprising:
determining a geographic region potentially affected by an environmental event;
identifying a person in the geographic area;
engaging in an electronic dialog with the person, the electronic dialog including at least one electronic message;
parsing the at least one electronic message to determine the geolocation of the communication device used by the person in the electronic dialog;
parsing the electronic dialog to determine equipment information about utility equipment within a vicinity of the geolocation of the person, the equipment information including the type of utility equipment and a condition of the utility equipment;
retrieving, based on the geolocation of the communication device and the equipment information, the identity of potentially damaged utility equipment from an inventory database, the utility equipment in the inventory database having associated information relating to geolocation;
generating a repair list including at least some of the identified potentially damaged utility equipment; and
determining repair equipment to repair the potentially damaged utility equipment on the repair list.

17. The method of claim 16, wherein determining the geographic region potentially affected by the environmental event comprises:
receiving, from an environmental events notification system, at least one electronic message regarding the environmental event; and
determining the geographic region based on the at least one electronic message.

18. The method of claim 16, wherein identifying the person in the geographic area comprises:
selecting a customer of the utility service residing in the geographic area.

19. The method of claim 16, wherein engaging in the electronic dialog with the person comprises:
sending, by a utility management server system, an electronic message to a communication device of the person.

20. The method of claim 19, wherein the electronic message is a text message that requests an observation from the person.

21. The method of claim 19, wherein sending the electronic message to the communication device of the person comprises:
activating an application for managing the electronic dialog, wherein the application is configured to execute on the communication device.

22. The method of claim 16, wherein engaging in the electronic dialog with the person comprises:
receiving, from the communication device, at least one electronic message including observations by the person regarding the vicinity of the geolocation, the observations including image data, text, or both.

23. The method of claim 22, wherein parsing the electronic dialog to determine equipment information comprises:
applying image analysis, text analysis, or both to the observations received from the communication device of the person to determine the type of utility equipment, the condition of the utility equipment, or both.

24. The method of claim 22, further comprising:
parsing the electronic dialog to determine impediments, in the vicinity of the geolocation of the person, to repairing the utility equipment.

25. The method of claim 24, wherein parsing the electronic dialog to determine the impediments comprises:
applying image analysis, text analysis, or both to the observations received from the communication device of the person.

26. The method of claim 16, wherein parsing the at least one electronic message comprises:
determining global positioning coordinates from geolocation metadata of the at least one electronic message.

27. The method of claim 16, wherein retrieving the identity of potentially damaged utility equipment from the inventory database comprises:
retrieving, from the inventory database, utility equipment with a geolocation within a predetermined distance of the geolocation of the communication device;
identifying, from the retrieved utility equipment, potentially damaged utility equipment based on the type of utility equipment determined from parsing the electronic dialog.

28. The method of claim 16, wherein determining the repair equipment comprises:
determining, for each identified potentially damaged utility equipment on the repair list, repair equipment for extracting the potentially damaged utility equipment and the repair equipment for installing new utility equipment.

29. The method of claim 24, wherein determining the repair equipment comprises:
determining, for each impediment to repairing the utility equipment determined by parsing the electronic dialog, repair equipment for removing the impediment.

30. The method of claim 16, further comprising:
storing, in the inventory database, the condition of the utility equipment with the retrieved identity of the utility equipment.

31. A computer program product including a non-transitory computer-readable medium having computer code thereon for locating and addressing potentially damaged utility equipment, the computer code comprising:
program code for determining a geographic region potentially affected by an environmental event;
program code for identifying a person in the geographic area;
program code for engaging in an electronic dialog with the person via a communication device used by the person, by (1) parsing at least one electronic message of the electronic dialog to determine a geolocation of the communication device, and (2) determining equipment information about utility equipment within a vicinity of the geolocation of the person, the equipment information including the type of utility equipment and a condition of the utility equipment;
program code for obtaining, based on the geolocation of the communication device and the equipment information, the identity of potentially damaged utility equipment;
program code for generating a repair list including at least some of the identified potentially damaged utility equipment; and
program code for determining repair equipment to repair the potentially damaged utility equipment on the repair list.

32. The computer program product of claim 31, wherein the program code for engaging in the electronic dialog comprises:
program code for determining global positioning coordinates from geolocation metadata of the at least one electronic message.

33. The computer program product of claim 31, wherein the program code for engaging in the electronic dialog comprises:
program code for applying image analysis, text analysis, or both to the at least one electronic message to determine the type of utility equipment, the condition of the utility equipment, or both.

34. The computer program product of claim 31, wherein the program code for obtaining the identity of potentially damaged utility equipment comprises:
program code for retrieving, from an inventory database, utility equipment with a geolocation within a predetermined distance of the geolocation of the communication device; and
program code for identifying, from the retrieved utility equipment, potentially damaged utility equipment based on the type of utility equipment determined from parsing the electronic dialog.

35. The computer program product of claim 31, further comprising:
program code for determining impediments, in the vicinity of the geolocation of the person, to repairing the utility equipment.

36. The computer program product of claim 31, wherein the program code for determining the repair equipment comprises:
program code for determining, for each identified potentially damaged utility equipment on the repair list, repair equipment for extracting the potentially damaged utility equipment and the repair equipment for installing new utility equipment.
